(19) United States
(12) Patent Application Publication
(10) Pub. No.: US 2015/0111180 A1
(43) Pub. Date: Apr. 23, 2015

(54) METHODS, SYSTEMS, AND COMPUTER READABLE MEDIA FOR CURSOR AND TEXT ENTRY FOR AIRCRAFT INTERFACE SIMULATION

(71) Applicant: AIRBUS (S.A.S), Blagnac (FR)

(72) Inventors: Katharyn WHELLER, PECHBONNIEU (FR); Wilfrid RUBIO ORTIZ, MONDONVILLE (FR); Stephane METIVET, CASTANET TOLOSAN (FR); Jacques-Andre DUPUY, TECOU (FR)

(21) Appl. No.: 14/061,675

(22) Filed: Oct. 23, 2013

(51) Int. Cl. G09B 9/08

(52) U.S. Cl. CPC G09B 9/08
USPC 434/30

(57) ABSTRACT

Methods, devices, and computer readable media are disclosed for simulating user interactions with a simulated aircraft cockpit, for example and without limitation, for aircraft simulation and training uses. In some aspects, a system for simulating user interactions with a simulated aircraft cockpit includes a simulation server including a hardware processor and configured to receive user interaction data from an interactive device and compute an output data based on the received user interaction data. In addition, the system also includes an application module configured to render the output data on a simulated aircraft cockpit screen.

### TECHNICAL FIELD

The subject matter described herein relates generally to aircraft cockpit simulations. More particularly, the subject matter disclosed herein relates to methods, devices, and computer readable media for simulating user interactions with a simulated aircraft cockpit.

### BACKGROUND

Recent generations of aircraft enable pilots and operators to interact with the aircraft control systems using a concept similar to standard personal computers. Certain aircraft display units, such as navigational displays (NDs), operational information systems (OISs), and multi-function displays (MFDs), display information that can be controlled by the use of a dedicated keyboard cursor control unit (KCCU). This control unit enables the movement of an avionics cursor or textual entries in the data fields on an aircraft display unit.

KCCUs utilize trackballs, wheels, validation buttons, navigation keys, and alphabetical keys similar to traditional personal computer inputs, offering operators ease-of-use in manipulating the multiple displays disposed about the aircraft control panel.

Accordingly, there is a need for methods, systems, and computer readable media that provide pilots and other operators the opportunity to simulate the use of an aviation cursor and/or textual entries in manipulating the aircraft displays. There is a further need for methods, systems, and computer readable media that offer a simulation of the interface that is as close as possible to the real cockpit, aircraft displays, and associated controls without impeding the ease of interaction or the functionality of the simulation.

### SUMMARY

According to one aspect, the subject matter described herein comprises a system for simulating user interactions with a simulated aircraft cockpit. The system includes a simulation server comprising a hardware processor and configured to receive user interaction data from an interactive device and compute an output data based on the received user interaction data. The system also includes an application module configured to render the output data on a simulated aircraft cockpit screen.

According to another aspect, the subject matter described herein comprises a method for simulating user interactions with a simulated aircraft cockpit. The method includes, at a simulated aircraft cockpit for simulating aircraft operations and comprising a hardware processor, placing a cursor on an avionics display, selecting the avionics display, and interacting with the selected avionics display.

As used herein, the terms “function”, “application”, and/or “module” refer to software in combination with hardware and/or firmware for implementing features described herein.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein can include non-transitory computer readable media such as, for example and without limitation, disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings, of which:

FIG. 1A is a diagram of an exemplary illustration of a system for simulating an aircraft cockpit with integrated interactive devices in accordance with aspects of the subject matter described herein;

FIG. 1B is a diagram of an exemplary illustration of a keyboard cursor control unit (KCCU) in accordance with aspects of the subject matter described herein;

FIG. 1C is a diagram of an exemplary illustration of a KCCU interacting with an avionics display in a simulated cockpit in accordance with aspects of the subject matter described herein;

FIG. 1D is a diagram of another exemplary illustration of a KCCU interacting with an avionics display in a simulated cockpit in accordance with aspects of the subject matter described herein;

FIG. 1E is a diagram illustrating an exemplary guidance message to inform a user to place the avionics cursor on the viewing screen in accordance with aspects of the subject matter described herein;

FIG. 2 is a diagram of an exemplary illustration of a simulation system for simulating KCCU operations within an aircraft cockpit in accordance with aspects of the subject matter described herein; and

FIG. 3 is a flow chart illustrating an exemplary method for managing user inputs to the cockpit simulation in accordance with aspects of the subject matter described herein.

### DETAILED DESCRIPTION

In accordance with the description herein and exemplary, associated drawings, novel methods, systems, and computer readable media are disclosed for simulating user interactions with a simulated aircraft cockpit. Such methods, systems and computer readable media are particularly suitable for use, for example and without limitation, for 3D modeling of a cockpit associated with an emulation of aircraft systems.

In some aspects, a system comprises a simulation server configured to receive user interaction data from an interactive device and compute an output data based on the received user interaction data can be provided to construct an interface as close as possible to a real life aircraft cockpit without impeding the ease of user interactions with the avionics instruments. The avionics instrument can, for example and without limitation, be a navigation display (ND), an onboard information system (OIS), a mail box interface, and/or a multi-function display (MFD). User interactions such as mouse movements and keystrokes are intercepted by an acquisition module and forwarded to the simulation server. The simulation server computes output data based on the received user interactions to display application modules. The display application modules render the user interactions on a 3D modeling of the aircraft cockpit.

In some aspects, user interactions come from or are generated by a keyboard cursor control unit (KCCU) placed on a central pedestal within the cockpit. The KCCU includes a set of cursor keys configured to select and activate an avionic instrument. Once an avionic instrument is activated, the user inputs aircraft operational commands via a keyboard on the KCCU. Commands such as flight plan modifications are received and performed by the simulation server and displayed on a navigation display via the display application module.

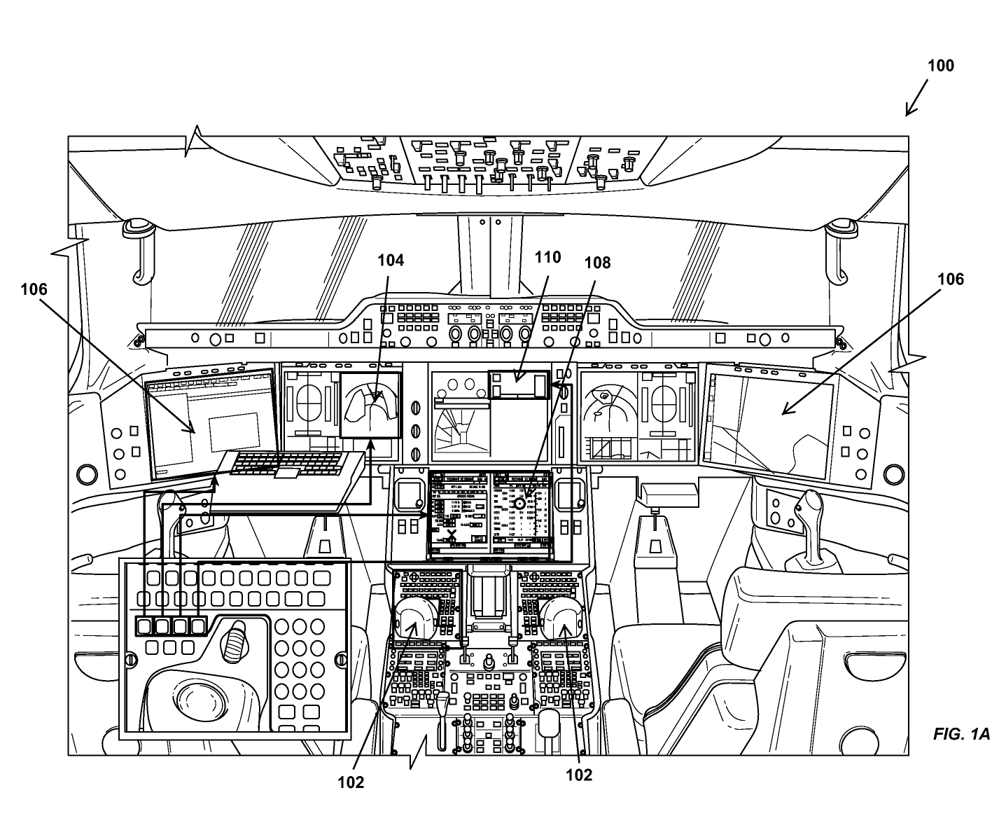

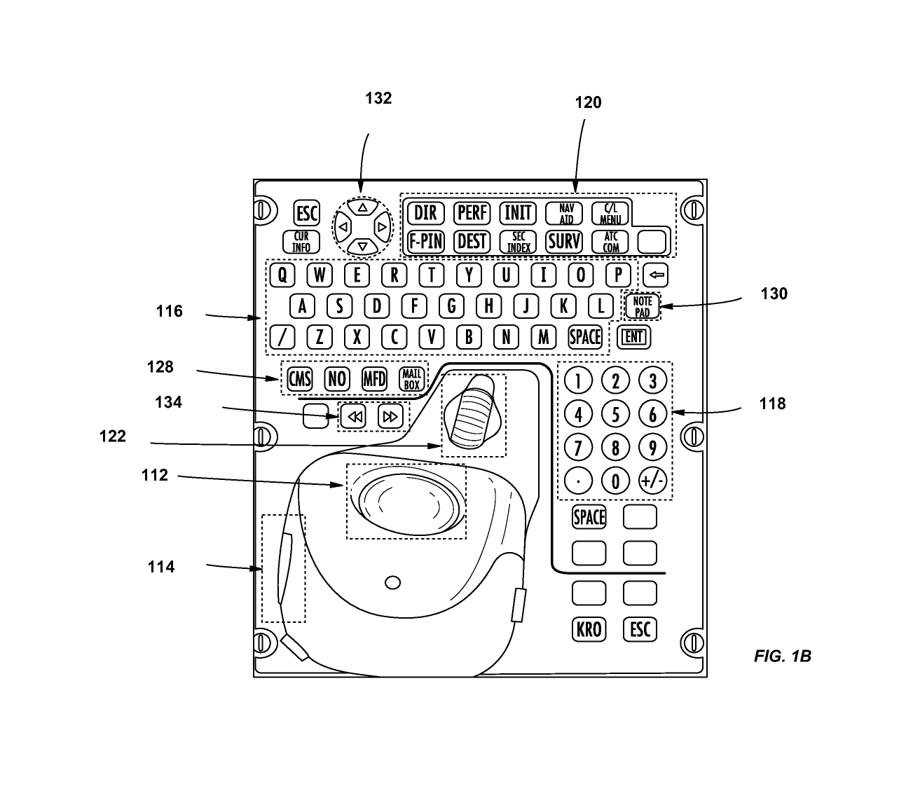

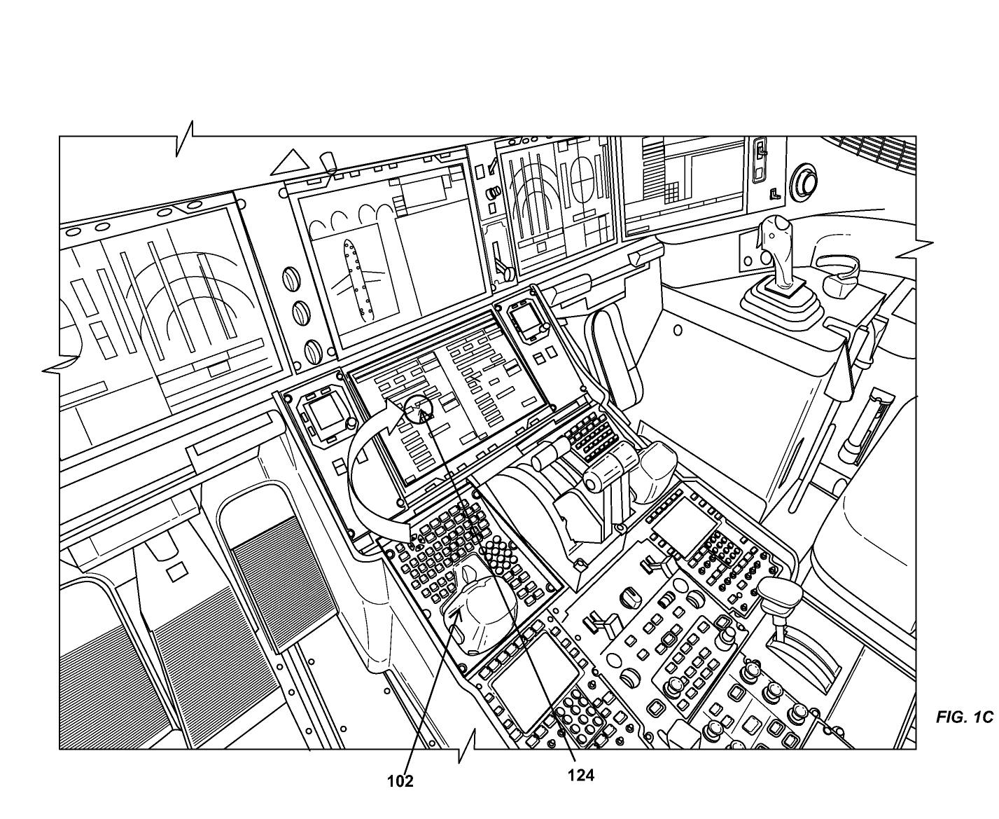

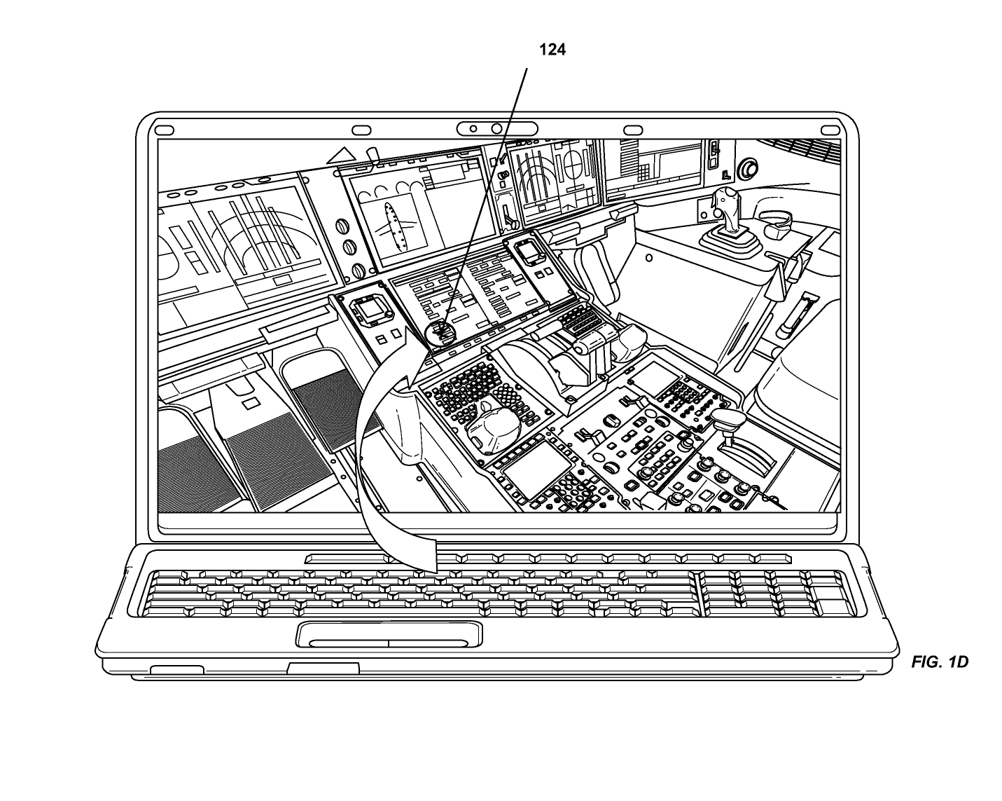

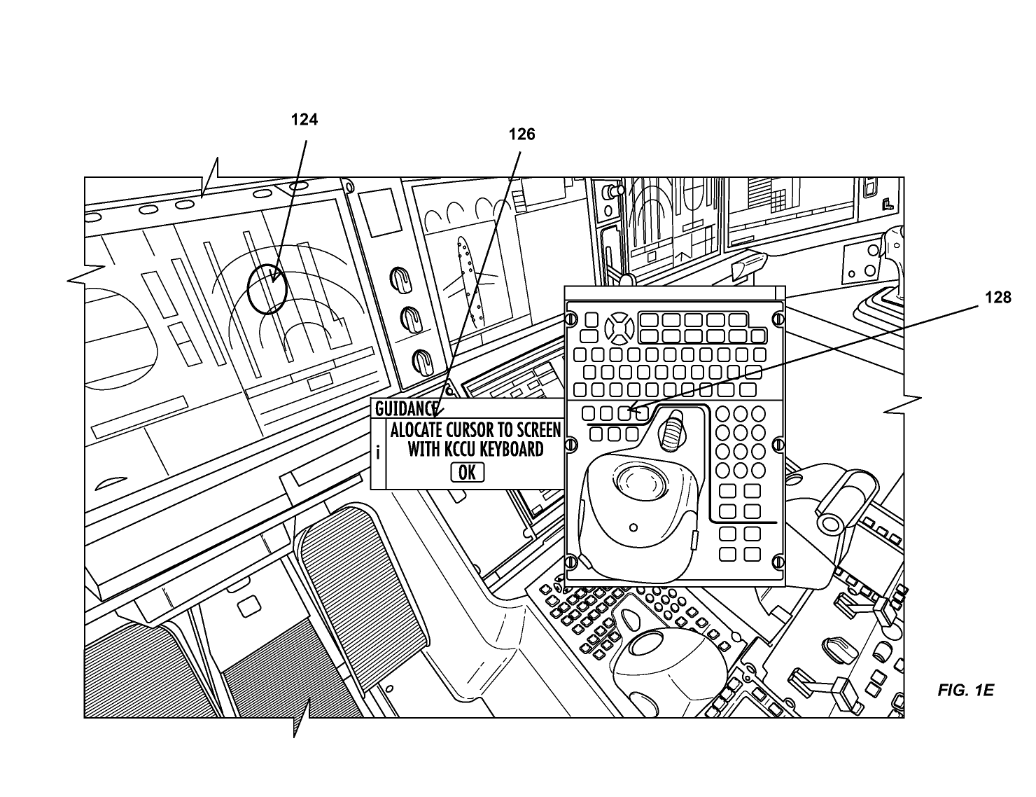

FIG. 1A depicts an exemplary illustration of a system, generally designated 100, for simulating an aircraft cockpit with integrated interactive devices in accordance with embodiments of the subject matter described herein. In some aspects, the interactive devices are Keyboard Cursor Control Units (KCCU) 102 configured to interact with a plurality of avionics instruments. As shown in FIG. 1A, the simulated aircraft cockpit can have two simulated KCCUs 102 located on the central pedestal, for both the captain and the first officer. In addition, the simulated cockpit can have two sets of interactive screens, one on the captain's side (left), another one on the first officer's side (right). Each set of interactive screens includes a navigation display (ND) 104 and an Onboard Information System (OIS) 106. The OIS 106 includes a set of electronic documentation and applications for flight, maintenance and cabin operations. For the flight crew, these applications replace previously used paper documentation and charts and enable an easy access to the necessary information related to an operational need. Both the ND 104 and OIS 106 are accessed via the KCCUs 102. Furthermore, the simulated aircraft cockpit includes a Multi-Function Display (MFD) 108 and a mailbox interface 110 configured to display mail messages. The MFD 108 is configured to display and control aircraft related data from sources such as the operator inputs on the interactive screens the Air Traffic Control (ATC), the SURVeillance (SURV), and/or the Flight Control Unit (FCU). Both the MFD 108 and the mail interface 110 are accessed by the KCCU 102. For example, the interactive screens can display more than 50 pages of textual data including information on the flight plan, aircraft position and/or flight performance. The flight crew can navigate through the pages and consult, enter or modify the data via the KCCU 102.

FIG. 1B illustrates an exemplary embodiment of a KCCU 102 in accordance with embodiments of the subject matter described herein. The KCCU 102 includes a cursor-control trackball 112 and a selector 114 that allows crews to point and click through menus on the MFD 108 or to make flight plan alterations by selecting new waypoints on the ND 104, including the vertical display. The KCCU 102 also houses or otherwise includes a keyboard with an alphabetic QWERTY keyboard 116, functional shortcuts 120, and a thumbwheel 122, numeric pad 118, notepad keys 130, cursor keys 128, direction arrow keys 132, navigation keys 134, and a backup cursor control device (CCD). In some aspects, the flight crew uses the KCCU 102 to navigate through the displayed pages of textual data on the MFD 108, enter and modify data on the MFD, and/or perform flight plan revisions on the lateral ND 104. The cockpit includes two KCCU 102 units, allowing both the captain and the first officer to directly interact with the onside ND 104, MFD 108, and the mailbox interface 110. Each KCCU displays its own avionics cursor, but only one can be active at any given time.

FIG. 1C depicts an exemplary illustration showing a KCCU 102 interacting with an avionics display in a simulated cockpit in accordance with embodiments of the subject matter described herein. In some aspects, an operator interacts with the simulated aircraft cockpit through an interactive device such as a computer mouse. For example, by left clicking and dragging a mouse the operator moves the mouse or trackball (e.g. KCCU) cursor onto a picture of an aircraft display (e.g. MFD 108) located within the simulated cockpit. The operator then clicks on the picture of the display (e.g. MFD 108) to activate the display. Upon activation, the display shows a colored frame (e.g. pink) around its edge, and the mouse or trackball cursor becomes an avionics cursor 124 which is confined to the colored frame. In this mode, movements of the KCCU track ball are simulated by a grab and drag movement on the computer mouse (e.g. left click with a simultaneous mouse movement). Furthermore, in some aspects, an operator changes the active aircraft display by mouse clicking on a displayed button of the KCCU 102. For example, clicking on a displayed button associated with an aircraft display (e.g. MFD 108) makes the aircraft cursor move onto that display. The operator then clicks on this display with the mouse cursor and activates the display for user interaction. Upon activation, the display shows a colored frame (e.g. pink) around its edge, and the mouse or trackball cursor becomes an avionics cursor 124 which is confined to the colored frame.

Alternatively, FIG. 1D depicts another mode in which a user interacts with avionics displays in the simulated aircraft cockpit in accordance with embodiments of the subject matter described herein. In some aspects, the KCCU 102 is mimicked by interactive devices such as a PC keyboard and mouse, or a laptop computer touchpad. For example, a user enters a KCCU mode by left clicking on an avionics display within the simulated cockpit. Within the KCCU mode, the avionics display appears activated with a colored frame (e.g. pink) around its edge, and the regular mouse cursor becomes no longer visible. An avionics cursor 124 instead appears on the activated avionics display and responds to movements of the mouse, and its range of movement is confined within the boundary of the display.

In some aspects, placement of the avionic cursor 124 can be made on the viewing screen to be activated before the KCCU mode is activated. As depicted in FIG. 1E, a guidance message 126 is displayed to inform the user to place the avionics cursor on the viewing screen in order to access the KCCU mode. This provides a more realistic simulation experience since on a real airplane an operator will need to place the avionics cursor 124 on a display before user interaction is initiated. In some aspects, an interactive KCCU in 2D is displayed allowing the user to position the cursor without introducing unwanted movement to the 3D simulated cockpit. The user optionally chooses to cancel the guidance message 126, which will not activate the KCCU mode, or use the cursor keys 128 on the displayed 2D KCCU to position the avionic cursor 124. For example, clicking MFD key of the cursor keys 128 positions the avionic cursor 124 on the MFD display 108 and activates the KCCU mode. If any other KCCU key in the 2D view is used or the user tries again to activate the KCCU mode without the avionic cursor in the screen, associate cursor keys are highlighted on the displayed KCCU in 2D. In some aspects, the KCCU mode is deactivated automatically when the avionics cursor remains static on the display boundary for a predefined period of time, or the user exits the KCCU mode such as by a right click on the mouse.

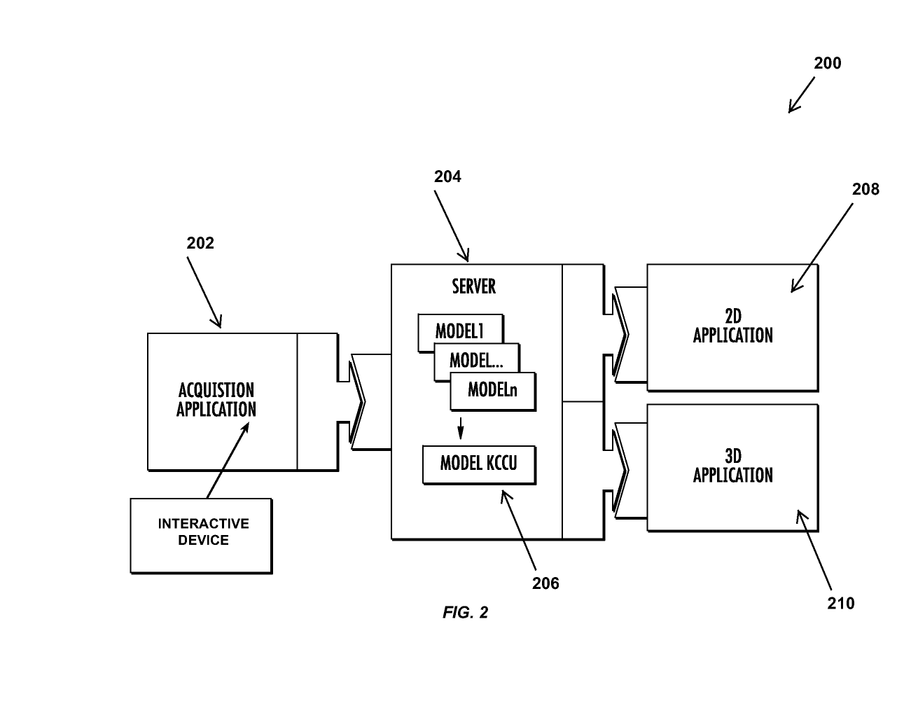

FIG. 2 depicts an exemplary illustration of a simulation system, generally designated 200, for simulating KCCU operations within an aircraft cockpit in accordance with embodiments of the subject matter described herein. As illustrated in FIG. 2, the simulation system utilizes a time-stepped simulation architectural model and includes four components that function within a single computer. In some aspects, the simulation system 200 includes an acquisition application module 202 configured to hook mouse and keystroke actions. A hook is a mechanism by which an application module intercepts events such as messages, mouse actions, and keystrokes, and a hook procedure is an application function that intercepts a particular type of event. After a mouse action or keystroke has been intercepted, it is transformed to a simulation data and sent to a time-stepped simulation server 204. In some aspects, the simulation server 204 is configured to schedule and/or run various aircraft simulation models and manage their static and runtime data (e.g. receive input data from one client and send output data to another client). For example, the simulation server 204 includes a KCCU simulation model 206 configured to manage KCCU trackball movement and keystroke input data. Input data such as trackball movements are transformed by the KCCU simulation model 206 into output data such as cursor positions on an avionic display. Similarly, the KCCU simulation model 206 performs received keystrokes, such as entering and modifying data on the MFD 108, and/or performing flight plan revisions on the lateral ND 104.

Furthermore, the simulation server 204 is configured to direct the transformed output data to display client modules such as a 2D 208 and/or 3D application module 210. As illustrated in FIG. 2, the simulation server 204 directs output data from the KCCU simulation model 206 to the 2D application module 208 for displaying the states of the aircraft systems (e.g. lights, screens) on the simulated cockpit. Displaying the aircraft system states is computed by a specific software library shared with the 3D application module 210, where the library is configured to compute an image upon reception of new output data from the KCCU simulation model 206. Similarly, transformed output data is directed to the 3D application module 210. The 3D application module 210 utilizes the same software library used by the 2D application module 208 for generating display images. However, the 3D application module 210 can choose not to use the generated images directly, but instead pre-process and sample the images to generate a mipmap which is then applied as a texture to a shape of polygon in the 3D modeling of the cockpit. The mipmap offers increased rendering speed and reduced aliasing artifacts within the 3D simulation. In addition, to further optimize and improve the rendering performance of the 3D simulation, the KCCU avionics cursor is represented on a different image than the screen image. Instead, the KCCU avionics cursor is in a specific texture on a specific polygon, and only this specific polygon moves whenever the cursor moves. This saves the 3D application module 210 from constantly refreshing its screen images every time the cursor moves, which is very expensive.

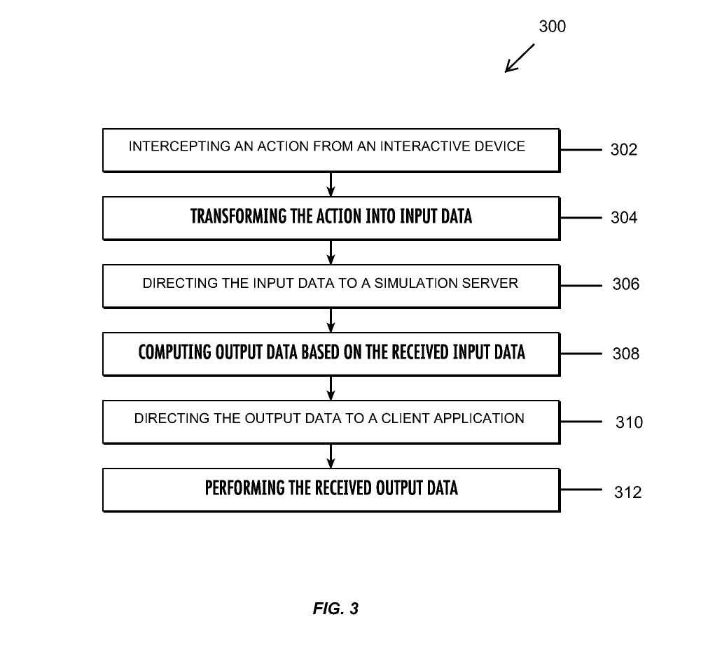

FIG. 3 is a flow chart illustrating an exemplary method, generally designated 300, for managing user inputs to the cockpit simulation in accordance with embodiments of the subject matter described herein. Referring to FIG. 3, in block 302, user actions such as mouse movements and/or key strokes are hooked by an acquisition application module 202. As described herein, a hook is a mechanism by which an application module intercepts events such as messages, mouse actions, and keystroke, and a hook procedure is an application function that intercepts a particular type of event. The intercepted or hooked mouse action or keystroke is then transformed into simulation data as indicated in block 304. In block 306 the transformed simulation data is directed to a time-stepped simulation server 204 configured to schedule and/or run various aircraft simulation models and manage their static and run time data (e.g. receive input data from one client and sent output data to another client). In some aspects, as indicated in block 308, the simulation server 204 computes output data based on the received transformed simulation data. For example, the simulation server 204 includes a KCCU simulation model 206 configured to manage KCCU trackball movement and keystroke input data. The KCCU simulation model 206 calculates output data such as cursor positions on avionic displays based on received inputs such as trackball movements. Similarly, the KCCU simulation model is also usable to enter and modify data on the MFD 108, and/or perform flight plan revisions on the lateral ND 104 based on the received keystrokes.

Furthermore, the simulation server 204 is configured to direct the computed output data such as cursor positions to client application modules such as the 2D 208 and/or 3D 210 display application modules, as indicated in block 310. In some aspects, a specific software library shared by the display application modules generates display images, and the display application modules then render the images on a simulation screen, as indicated in block 312. For example, the 2D application module 208 is configured to render the generated images directly, while the 3D application module 210 pre-processes and samples the images to generate a mipmap which is applied as a texture to a shape of polygon in the 3D modeling of the cockpit.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for simulating user interaction with a simulated aircraft cockpit, the system comprising:
a display unit configured to display at least one avionics display of a simulated aircraft cockpit;
a simulation server comprising a hardware processor and configured to receive user interaction data from an interactive device and compute an output data based on the received user interaction data; and
an application module configured to render the output data on a simulated aircraft cockpit screen;
wherein the simulation server comprises a keyboard cursor control unit (KCCU) module configured to compute output data based on the received user interaction data.

2. The system of claim 1 wherein the avionics display comprises at least one of: a navigation display (ND), an onboard information system (OIS), a mail box interface, and/or a multi-function display (MFD).

3. The system of claim 1 wherein the user interaction data comprises at least one of: left clicking a mouse combined with a simultaneous mouse movement or a keystroke on a keyboard.

4. The system of claim 1 wherein the interactive device comprises a keyboard cursor control unit (KCCU).

5. The system of claim 1 wherein the interactive device comprises at least one of: a set of numeric keys, a validation button, a trackball, a scrolling wheel, a set of navigation keys configured to navigate a cursor on an avionics display, a set of alphabet keys, a set of direction arrow keys, a set of function keys, a mouse, a touchpad, and/or a set of cursor keys configured to select an avionics display.

6. The system of claim 1 further comprising an acquisition application module configured to intercept a user interaction, transform the intercepted interaction to a simulation data, and direct the simulation data to the simulation server.

7. The system of claim 1 further comprising a software library configured to compute a display image based on the output data from the simulation server.

8. The system of claim 7 wherein the application module comprises a 2D application module configured to display the computed image.

9. The system of claim 7 wherein the application module comprises a 3D application module configured to process and sample the computed image to generate a mipmap type output data. 20

10. The system of claim 1 wherein the application module comprises a 2D application module configured to display a two dimensional interactive device.

11. The system of claim 10 wherein the two dimensional interactive device comprises a keyboard cursor control unit (KCCU) configured to place a cursor key on an avionics display.

12. A method for simulating user interactions with a simulated aircraft cockpit, the method comprising:
at a simulated aircraft cockpit for simulating aircraft operations and comprising a hardware processor:
displaying at least one avionics display of the simulated aircraft cockpit on a display unit;
placing a cursor on an avionics display;
selecting the avionics display; and
interacting with the selected avionics display.

13. The method of claim 12 wherein selecting the avionics display further comprises the selected avionics display displaying a colored frame around its edge.

14. The method of claim 12 wherein selecting the avionics display further comprises replacing the cursor with an avionics cursor confined within the selected avionics display.

15. The method of claim 12 wherein selecting the avionics display further comprises:
selecting an displayed button on an interactive device;
activating an aircraft display; and
interacting with the activated aircraft display.

16. The method of claim 15 wherein the displayed button is associated with an aircraft display and selecting a displayed button further comprises moving an avionics cursor onto the associated aircraft display.

17. The method of claim 12 wherein interacting with the selected avionics display comprises:
intercepting a user interaction via an acquisition application module;
transforming the user interaction into a simulation data;
computing a display image based on the simulation data; and
displaying the simulation data on the simulated aircraft cockpit.

18. The method of claim 17 wherein transforming the user interaction further comprises directing the transformed simulation data to a simulation server configured to compute an output data based on the transformed simulation data.

19. The method of claim 18 wherein computing an output data based on the transformed simulation data comprises computing a cursor position using a keyboard cursor control unit (KCCU) model.

20. The method of claim 17 wherein computing a display image comprises computing the image via a software library shared by a 2D and a 3D display application module.

21. The method of claim 17 wherein displaying the simulation data comprises a 2D display application module displaying the computed image.

22. The method of claim 17 wherein displaying the simulation data comprises a 3D display application module processing and sampling the computed image to generate a mipmap type output data.

23. A non-transitory computer readable medium having stored thereon executable instructions that when executed by the processor of a computer control the computer to perform steps comprising:
at a simulated aircraft cockpit for simulating aircraft operations and comprising a hardware processor:
placing a cursor on an avionics display;
selecting the avionics display; and
interacting with the selected avionics display.

24. The non-transitory computer readable medium of claim 23 wherein interacting with the selected avionics display comprises:
intercepting a user interaction via an acquisition application module;
transforming the user interaction into a simulation data;
computing a display image based on the simulation data; and
displaying the simulation data on the simulated aircraft cockpit.
